(19) United States
(12) Patent Application Publication
(10) Pub. No.: US 2025/0370429 A1
(43) Pub. Date: Dec. 4, 2025

(54) METHOD FOR STEADY-STATE CONTROL OF CUTTING STATE

(71) Applicant: SHANDONG UNIVERSITY, Jinan (CN)

(72) Inventors: Chuanzhen HUANG, Jinan (CN); Zhengyi Tang, Jinan (CN); Hanlian Liu, Jinan (CN); Hongtao Zhu, Jinan (CN); Bin Zou, Jinan (CN); Peng Yao, Jinan (CN); Jun Wang, Jinan (CN)

(73) Assignee: SHANDONG UNIVERSITY, Jinan (CN)

(21) Appl. No.: 19/303,010

(22) Filed: Aug. 18, 2025

Related U.S. Application Data
(63) Continuation-in-part of application No. 17/619,092, filed on Dec. 14, 2021.

(30) Foreign Application Priority Data
Dec. 2, 2020 (CN) 2020113908212

(51) Int. Cl. G05B 19/4097; B23B 7/12

(52) U.S. Cl. CPC G05B 19/4097; B23B 7/12; G05B 2219/34165; G05B 2219/45044

(57) ABSTRACT

A method for steady-state control of cutting state, implemented based on computer numerical control (CNC) machine tools or cutting lathes. The method comprises: fitting parameters of a stored energy evolution model of a workpiece material to be machined; discretizing primary shear zone into multiple infinitesimals along normal direction of main shear plane; introducing equivalent cutting edge model, inputting pre-used cutting parameters, calculating strain and strain rate of each infinitesimal and analyzing temperature of each infinitesimal; deducing and solving differential equation of each infinitesimal of stored energy to position of the primary shear zone by taking initial shear plane of the primary shear zone as model boundary; determining application values of cutting parameters according to solved results; and, controlling and adjusting the cutting tool in the actual cutting process to cut the workpiece material to be machined with the application values.

### CROSS-REFERENCES TO RELATED APPLICATIONS

The present invention is a continuation-in-part of U.S. application Ser. No. 17/619,092, filed on Dec. 14, 2021, which claims priority to International Application number PCT/CN2021/073123, entitled “Method and System for Calculating Stored Energy Field of Primary Shear Zone During Steady-state Cutting”, as filed on Jan. 21, 2021, which claims priority to Chinese Application number 202011390821.2, as filed on Dec. 2, 2020. The entirety of each of the above-mentioned patent applications is hereby incorporated by reference herein and made a part of this specification.

### TECHNICAL FIELD

The present invention belongs to the field of cutting technologies, and in particular, relates to a method for steady-state control of cutting state.

### BACKGROUND

Descriptions herein only provide background techniques related to the present invention, and do not necessarily constitute the related art.

Metal cutting is a significant process for the formation of metallic materials and production of mechanical components, which is a complex thermal-mechanical coupling process encompassing the fields of machinery, materials and dynamics. The process includes a plurality of phenomena such as large elastoplastic deformation, a high temperature, a high strain rate, severe friction, and material failure. Therefore, performing research on the cutting mechanism to find out the relationship between the input (such as a machine tool system, machining parameters, tool parameters, and workpiece performance) and the output (such as the integrity of a machined surface and the service performance of components) of the cutting process is of great significance. The inventor found that, due to the complexity of the cutting process, most current researches on the cutting mechanism are limited to the empirical formulas and the phenomenological models, failing to provide a fundamental formation mechanism of a machined surface. The cutting process always includes input, output, storage, and dissipation of energy. The same is true for macroscopic deformation and structural transformation or microscopic dislocations, grain slip, recrystallization, and phase transformation. In addition, the research showed that the energy storage and dissipation of the machined surface greatly affects the performance and the surface integrity of the material.

### SUMMARY

In the traditional research of the cutting mechanism, the stress field has directionality, excessive characteristic parameters are present, and the research process is complex. In view of the shortcomings of the prior art, the present invention provides a method and system for calculating a stored energy field of the primary shear zone during steady-state cutting, further provides a method for steady-state control of cutting state, to predict a cutting force, a cutting temperature, a chip morphology, and material properties by using a stored energy distribution of the primary shear zone, and obtain control parameters of steady cutting of a cutting tool according to the prediction results to implement a steady control of a working (cutting) state of the cutting tool in an actual machining process.

To achieve the foregoing objective, the present invention is implemented by the following technical solutions.

In a first aspect, the technical solutions of the present invention provide a method for calculating a stored energy field of the primary shear zone during steady-state cutting. The method includes steps of:
fitting parameters of a stored energy evolution model of a workpiece material;
performing infinitesimal division on the primary shear zone;
simplifying actual three-dimensional cutting into two-dimensional cutting, performing analysis to obtain a shear plane model, calculating a strain and a strain rate of each infinitesimal, and analyzing a temperature of the each infinitesimal;
deriving a differential equation of stored energy versus location by using the stored energy evolution model, a strain rate distribution model, a strain distribution model, and a temperature distribution model; and
solving the differential equation of stored energy versus location for the each infinitesimal by using an initial shear plane of the primary shear zone as a model boundary, to obtain stored energy at each location, so as to obtain a stored energy field distribution of the primary shear zone.

In a second aspect, the technical solutions of the present invention further provide a system for calculating a stored energy field of the primary shear zone during steady-state cutting. The system includes:
a fitting unit, configured to fit parameters of a stored energy evolution model of a workpiece material;
an infinitesimal generation unit, configured to perform infinitesimal division on the primary shear zone;
a conversion unit, configured to simplify actual three-dimensional cutting into two-dimensional cutting; and
a solving module, configured to receive data outputted by the fitting unit, the infinitesimal generation unit, and the conversion unit, calculate a strain and a strain rate of each infinitesimal and analyze a temperature of the each infinitesimal according to the data outputted by the conversion unit, derive a differential equation of stored energy versus location of the primary shear zone by using the stored energy evolution model of the fitting unit, and solve the differential equation of stored energy versus location for the each infinitesimal divided by the infinitesimal generation unit, to obtain a stored energy field distribution of the primary shear zone.

In a third aspect, the technical solutions of the present invention further provide a method for steady-state control of cutting state, comprising the following steps:
fitting parameters of a stored energy evolution model of a workpiece material to be machined based on stress-strain curves of the workpiece material to be machined in different deformation conditions;
performing infinitesimal division on the primary shear zone;
simplifying an actual three-dimensional (3D) cutting into a two-dimensional (2D) cutting, obtaining a shear plane model by analyzing the 2D cutting;
inputting multiple groups of data of cutting speed and cutting depth pre-used in an actual cutting process into the shear plane model, calculating a strain and a strain rate of each of infinitesimals, and analyzing temperature of the each of the infinitesimals;
deriving a differential equation of stored energy versus location by using the stored energy evolution model, a strain rate distribution model, a strain distribution model, and a temperature distribution model;
solving the differential equation of stored energy versus location for the each of the infinitesimals by using an initial shear plane of the primary shear zone as a model boundary, to obtain stored energy at each location, so as to obtain a stored energy field distribution of the primary shear zone;
analyzing the stored energy field distribution of the primary shear zone, predicting a cutting force, cutting temperature, and a chip morphology during the actual cutting process;
when the predicted cutting force, cutting temperature, and/or chip morphology obtained from a certain prediction calculation meet the predefined steady-state requirements of the cutting state, the pre-used data of the cutting speed and cutting depth input in the certain prediction calculation are used as application values of steady-state control of a cutting tool in the actual cutting process; and
controlling and adjusting a cutting state of the cutting tool in the actual cutting process to process the workpiece material to be machined by using the application values of the cutting speed and the cutting depth, so as to maintain the actual cutting process in a steady-state and obtain expected material properties of a machined workpiece material.

The technical solutions of the present invention have the following beneficial effects:
1) By means of the calculation method and system disclosed in the present invention, the stored energy distribution during the cutting can be studied, and the complex thermal-mechanical coupling process can be simplified. By means of the research of the energy consumption of the microstructures, the machining parameters can be associated with the final properties of the materials. Energy, which is a scalar closer to the physical nature of material formation or integration, is used as a link running through the material machining to obtain desired material properties. This is of great significance to promote the research of the cutting mechanism.
2) The present invention fills up the gap in the existing cutting mechanism research technology. Based on the shear plane model in the traditional research of the cutting mechanism, the equivalent cutting edge model was first introduced to simplify three-dimensional cutting into two-dimensional cutting. Then, the established stored energy evolution model of the machined material and the strain rate distribution model, the strain distribution model, and the temperature distribution model of the primary shear zone during the cutting are substituted into the shear plane model, and the differential equation of stored energy versus location in the primary shear zone is obtained to obtain the stored energy distribution of the primary shear zone. Finally, the stress field and the temperature field of the primary shear zone are analyzed based on the obtained stored energy distribution, and the cutting force, the cutting temperature, and the material modification are further predicted. The stored energy field runs through the entire cutting process, and the cutting mechanism is explained more deeply, completely, and clearly in a simpler way than the existing calculation method, greatly promoting the research of the cutting mechanism.

### BRIEF DESCRIPTION OF THE DRAWINGS

The accompanying drawings constituting a part of the present invention are used to provide further understanding of the present invention. The exemplary examples of the present invention and descriptions thereof are used to explain the present invention, and do not constitute an improper limitation to the present invention.

FIG. 1 is a schematic diagram of a shear zone model according to one or more implementations of the present invention.

FIG. 2 is a block diagram of a stored energy field calculation program according to one or more implementations of the present invention.

FIG. 3 is a schematic diagram of stored energy field distributions of the primary shear zone in the conditions of different cutting parameters according to one or more implementations of the present invention.

FIG. 4 is a schematic diagram of a stress field prediction result of the primary shear zone according to one or more implementations of the present invention.

FIG. 5 is a schematic diagram of a temperature field prediction result of the primary shear zone according to one or more implementations of the present invention.

FIG. 6 is a schematic diagram of a method for steady-state control of cutting state according to one or more implementations of the present invention.

The spacing or dimensions between each part are exaggerated to show the position of each part, and the schematic diagrams are used only for illustrative purposes.

### DETAILED DESCRIPTION

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the present invention clearly dictates otherwise. In addition, it should be further understood that, terms “include” and/or “including” used in this specification indicate that there are features, steps, operations, devices, components, and/or combinations thereof.

For convenience of description, the terms “above”, “below”, “left”, and “right” only indicate directions consistent with those of the accompanying drawings, are not intended to limit the structure, and are used only for ease and brevity of illustration and description, rather than indicating or implying that the mentioned device or element needs to have a particular orientation or needs to be constructed and operated in a particular orientation. Therefore, such terms should not be construed as a limitation on the present invention.

For the part of term explanation, terms in the present invention such as “mount”, “connect”, “connection”, and “fix” should be understood in a broad sense. For example, the connection may be a fixed connection, a detachable connection, or an integral connection, a mechanical connection, an electrical connection, a direct connection, an indirect connection by using an intermediate medium, an interior connection between two components, or interaction between two components. A person of ordinary skill in the art may understand specific meanings of the foregoing terms in the present invention according to a specific situation.

As described in the background, in the traditional research of a cutting mechanism, the stress field has directionality, excessive characteristic parameters are present, and the research process is complex. In view of the shortcomings of the prior art, the present invention provides a method and system for calculating a stored energy field of the primary shear zone during steady-state cutting, to predict a cutting force, a cutting temperature, a chip morphology, and material properties by using a stored energy distribution of the primary shear zone.

### Example 1

In a typical implementation of the present invention, the present example discloses a method for calculating a stored energy field of the primary shear zone during steady-state cutting. The method includes the following steps:

(1) Fitting parameters of a stored energy evolution model of a workpiece material based on stress-strain curves of the workpiece material in different deformation conditions, where the model is related to the temperature, strain, and strain rate. Stored energy Eₛ may be represented by a dislocation density ρₜₒₜₐₗ. That is to say:

$${E}_{s} = αμ {b}^{2} {ρ}_{total} / χ ,$$

wherein, a is a dislocation interaction parameter having a value of 0.5, u is a shear modulus of the material, b is a value of a Burgers vector, and χ is a proportionality coefficient allowing for alloying elements and having a value of 0.6. Therefore, the establishment of the stored energy evolution model depends on a dislocation density evolution model. According to a dislocation density type, the dislocation density includes a statistical stored dislocation density ρₛ and a geometrically necessary dislocation density ρ_{LABs}. Therefore, the dislocation density is:

$${ρ}_{total} = ( 1 - f ) {ρ}_{s} + f {ρ}_{L ABs} ,$$

wherein, f is a volume fraction of a geometrically necessary dislocation, which may be expressed by a dislocation cell structure diameter D_{cell} and the dislocation cell wall thickness δ as:

$$f = {[ ( {D}_{c e l l} - δ ) / {D}_{c e l l} ]}^{3} .$$

The dislocation cell wall thickness δ is 1.28×10⁻⁹ m, and the dislocation cell structure diameter is expressed as:

$${D}_{cell} = {k}_{cell} / \sqrt{{ρ}_{total}} ,$$

wherein, k_{cell} is a material constant. Evolution equations of the statistical stored dislocation density ρₛ and the geometrically necessary dislocation density ρ_{LABs} with a strain γ are:

$$d {ρ}_{s} / d γ = {( b {D}_{cell} )}^{- 1} \sqrt{{ρ}_{s}} - r {ρ}_{s} ,$$

$$d {ρ}_{LABs} / d γ = \sqrt{2 {ρ}_{m} / 3} {D}_{cell} / δ b ,$$

wherein, r is a recovery coefficient, which is obtained by fitting results of stress-strain curves at different strain rates and different temperatures, and ρₘ is a mobile dislocation density.

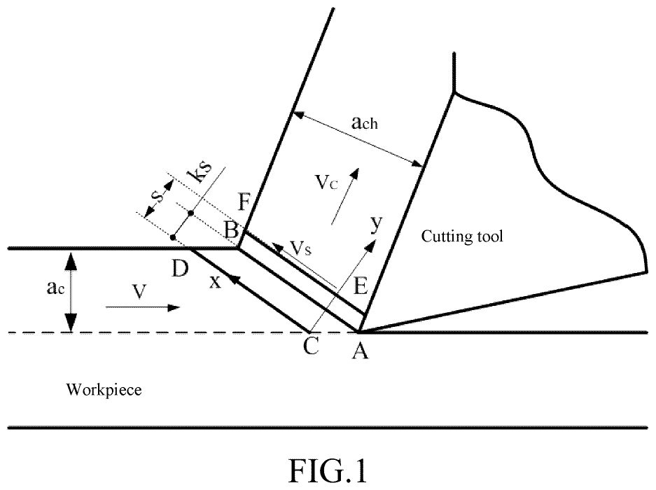

(2) As shown in FIG. 1, a zone CDFE is the primary shear zone, CD is an initial shear plane, EF is a final shear plane, and AB is a main shear plane. In order to reduce the complexity of the analysis, the primary shear zone is discretized into N infinitesimals from CD to EF in a normal direction of AB, that is, N+1 planes. When N is large enough, a strain rate and a temperature in each infinitesimal may be assumed as constants.

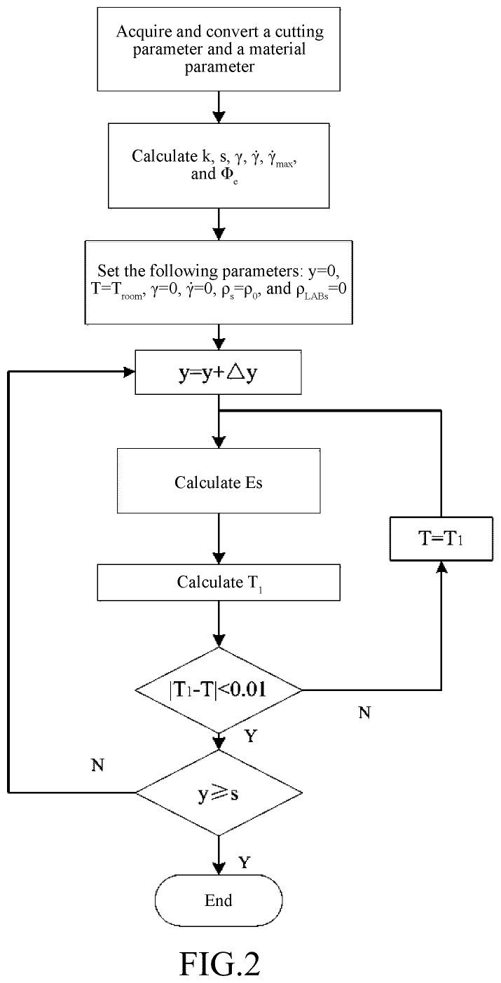

(3) Introducing an equivalent cutting edge model, as shown in FIG. 2, define two ends of an actual cutting tool as an equivalent cutting edge, simplify actual 3D cutting into 2D cutting, and calculate distributions of a strain rate \dot{γ} and a strain γ of the primary shear zone according to a shear plane model:

$$\dot{γ} = \{ \begin{matrix}\frac{{\dot{γ}}_{max}}{ks} y & 0 < y < ks \\ \frac{{\dot{γ}}_{max}}{s - ks} ( s - y ) & ks < y < s\end{matrix} ,$$

$$γ = \{ \begin{matrix}\frac{{\dot{γ}}_{max}}{2 ksV sin {ϕ}_{e}} {y}^{2} & 0 < y < ks \\ \frac{{\dot{γ}}_{max}}{2 ( 1 - k ) sV sin {ϕ}_{e}} ( 2 sy - {y}^{2} - 2 ks ) & ks \leq y < s\end{matrix} ,$$

wherein, s is a thickness of the primary shear zone, k is a ratio of a distance from CD to AB to a distance from AB to EF, y is a distance from a point in a cutting zone to CD, \dot{γ}ₘₐₓ is a maximum strain rate in the primary shear zone, ϕₑ is a shear angle, and V is a cutting speed. \dot{γ}ₘₐₓ and k may be expressed as:

$${\dot{γ}}_{max} = \frac{2 V cos {γ}_{e}}{\sqrt{3} s cos ( {ϕ}_{e} - {γ}_{e} )} ,$$

$$k = \frac{cos {ϕ}_{e} cos ( {ϕ}_{e} - {γ}_{e} )}{cos {γ}_{e}} .$$

A thickness of the shear zone is obtained according to the empirical formula of Oxley:

$$s = \frac{{a}_{c}}{5.9 sin {ϕ}_{e}} .$$

In order to obtain the shear angle, experiments are usually required to obtain a deformation coefficient. For simplicity, in the present example, an approximate shear angle formula of Merchant is used:

$${ϕ}_{e} = \frac{π}{4} - \frac{β}{2} + \frac{{γ}_{e}}{2} ,$$

wherein, β is a friction angle. The model does not allow for the influence of the cutting speed on a friction coefficient. Therefore, β is a constant.

According to the distribution laws of the strain and the strain rate, the formula is substituted into a center position of the each infinitesimal, to obtain an average strain and an average strain rate of the each infinitesimal. The average strain and the average strain rate are respectively used as a strain feature value and a strain rate feature value of the each infinitesimal.

According to the heat conduction equation, the temperature value of the K^{th} plane is represented by a temperature value of a (K−1)^{th} plane:

$${T}_{K} = {T}_{K - 1} + \frac{{R}_{1}}{ρ cV sin {ϕ}_{e}} {\int }_{{y}_{K - 1}}^{{y}_{K}} Qdy ,$$

wherein, R₁ is a ratio of mass transfer to heat transfer during the cutting, ρ and c are respectively a density and a specific heat capacity of the workpiece material, y_{K} and y_{K-1} are respectively coordinates of the K^{th} plane and the (K−1)^{th} plane, and Q is heat generated per unit time and per unit volume in the each infinitesimal.

(4) Deriving a differential equation of stored energy versus location y by using the stored energy evolution model:

$$\frac{{dE}_{s}}{dy} = \frac{{dE}_{s} d γ}{d γ dy} + \frac{{dE}_{s} d \dot{γ}}{d \dot{γ} dy} + \frac{{dE}_{s} dT}{dTdy} .$$

Since the strain rate and the temperature in the each infinitesimal are both regarded as constants, the differential equation in the each infinitesimal may be simplified. Finally, stored energy E_{s|k} of the K^{th} plane is calculated by stored energy E_{s|K-1} of the (K−1)^{th} plane:

$${E}_{s \vert K} = {E}_{s \vert K - 1} + \frac{d ψ ( {\dot{γ}}_{AVE} , \overline{T} )}{d γ} \frac{d γ}{dy} dy .$$

The initial shear plane of the primary shear zone is used as a model boundary. Stored energy of a next plane is calculated in the each infinitesimal according to the foregoing formula, to obtain stored energy of all (N+1)^{th} planes. The stored energy of all planes is used as the stored energy of the location in the primary shear zone. That is to say, the stored energy field distribution of the primary shear zone is obtained. The specific stored energy calculation process is shown in the process block diagram in FIG. 2.

(5) Predicting a stress field and a temperature field of the primary shear zone based on the stored energy field, and then analyze the cutting force, the cutting temperature, a chip forming law, and the material modification.

According to the foregoing technical solutions, the coefficient k_{cell} in step (1) may be obtained in two ways. In the first way, the coefficient may be estimated as μ/200. In the second way, the dislocation density ρₜₒₜₐₗ and the dislocation cell diameter D_{cell} after the machining are measured by experiments, and then k_{cell}=D_{cell}\sqrt{ρₜₒₜₐₗ} is calculated.

The recovery factor r is a function of the strain rate and the temperature, which is expressed as:

$$r = [ Aexp ( - \frac{\dot{γ}}{{\dot{γ}}_{0}} ) + B ] exp ( mT ) ,$$

wherein, A, B, and m are all parameters obtained by fitting the stress-strain curve.

According to the foregoing technical solutions, the primary shear zone in the steady-cutting process is discretized into N infinitesimals in a normal direction of the main shear plane, and a strain rate and a temperature in each infinitesimal are regarded as constants to simplify a solving process of a differential equation.

According to the foregoing technical solutions, a line connecting two end points of an actual cutting edge projected on a base plane is defined as an equivalent cutting edge, a cutting tool angle of the equivalent cutting edge is calculated according to a geometric relationship and is used as an actual cutting tool angle, and then a strain distribution and a strain rate distribution of the primary shear zone are calculated by using a normal rake angle of the equivalent cutting edge as an input parameter of the shear plane model.

According to the foregoing technical solutions, stored energy of the discrete planes in the primary shear zone in step (4) may be obtained by solving the following mathematical physical problem:

Boundary conditions are as follows: the initial shear plane is used as a model boundary, that is, an 0^{th} plane in the (N+1) ^{th} planes obtained by division, and it is assumed according to the experimental results and the models that a temperature of the initial shear plane is a room temperature (25° C.), a strain and a strain rate are both 0, and stored energy is stored energy of an initial material.

A mathematical physical equation is:

$${E}_{s \vert K} = {E}_{s \vert K - 1} + \frac{d ψ ( {\dot{γ}}_{AVE} , \overline{T} )}{d γ} \frac{d γ}{dy} dy .$$

The equation may be explained as follows: The stored energy of the K^{th} plane may be obtained by integration of the stored energy of the (K−1)^{th} plane, wherein \dot{γ}_{AVE} and T̅ are respectively a feature strain rate and a feature temperature of a K^{th} element.

According to the foregoing technical solutions, the stored energy-based shear stress field prediction in step (5) is based on a mapping relationship between stored energy and a dislocation density and a mapping relationship between a shear flow stress and a dislocation density. The mapping relationship between a shear stress and a dislocation density may be expressed as:

$$τ = \frac{1}{\sqrt{3}} ( {τ}_{0} + M ( {α}_{s} μ b \sqrt{{ρ}_{f}} ) + {τ}_{1} μ {\{ 1 - {[ \frac{{k}_{b} T}{Δ F} ln ( \frac{{\dot{ε}}_{p}}{{\dot{ε}}_{0}} ) ]}^{\frac{1}{p}} \}}^{\frac{1}{q}} ) .$$

In the formula, the first term to is a non-thermal stress independent of the strain rate during movement of a dislocation, the second term is a long-range stress of the movement of the dislocation, and the third term is the short-range stress during the movement of the dislocation. M is a Taylor coefficient, as is a constant generally having a value of 0.3-0.5, Tiu is a stress value required for the dislocation to cross an obstacle without the assistance of thermal activation, where a value thereof mainly depends on a strength of the obstacle during the movement of the dislocation, the constants p and q satisfy 0<p≤1 and 1≤q≤2, and values thereof depend on a shape of the energy barrier, ΔF=f₂μb³ is Helmholtz free energy required by the dislocation to overcome the short-range barrier without the assistance of an external force, k_{b} is a Boltzmann constant, T is an absolute temperature, and \dot{ϵ}ₚ and \dot{ϵ}₀ are respectively a plastic strain rate and a reference strain rate. According to the mapping relationship between stored energy and a dislocation density, a shear flow stress prediction formula based on the stored energy is obtained as:

$$τ = {τ}_{0} + M ( αμ b \sqrt{{E}_{s} χ / {α}_{s} μ {b}^{2}} ) + {τ}_{1} μ {\{ 1 - {[ \frac{{k}_{b} T}{Δ F} ln ( \frac{{\dot{ε}}_{p}}{{\dot{ε}}_{0}} ) ]}^{\frac{1}{p}} \}}^{\frac{1}{q}} ,$$

wherein, B is a lattice damping coefficient, and ρₘ is a mobile dislocation density.

According to the foregoing technical solutions, a normal stress κ perpendicular to the main shear plane is calculated based on a Hencky equation:

$$\frac{\partial κ}{\partial {y}_{e}} + 2 τ \frac{\partial ψ}{\partial {y}_{e}} - \frac{\partial τ}{\partial {x}_{e}} = 0 ,$$

wherein, Ω is a turn of a shear line. Therefore, by means of integration, a distribution of κ can be obtained.

A normal stress K_{A} at a free surface may be estimated by a stress at the free surface. Therefore:

$${κ}_{A} = τ [ 1 + 2 ( \frac{π}{4} - {ϕ}_{e} ) ] .$$

A chip morphology prediction method is as follows: It is assumed the loading stage exists before the main shear plane and an unloading stage exists after the main shear plane AB. If a stored energy peak occurs at a location before AB, it may be considered that adiabatic shear occurs in the cutting condition and sawtooth chips are formed.

According to the foregoing technical solutions, a microhardness prediction formula based on the stored energy is:

$${H}_{v} = \frac{{σ}_{0} + M αμ b \sqrt{χ {E}_{s} / αμ {b}^{2}}}{{C}_{H}} ,$$

wherein, σ₀=Mτ₀, M is a Taylor coefficient having a value of 3.06, and C_{H} is a material constant.

A microscopic residual stress may be directly represented by the stored energy.

The present example fills up the gap in the existing cutting mechanism research technology. Based on the shear plane model in the traditional research of the cutting mechanism, the equivalent cutting edge model was first introduced to simplify three-dimensional cutting into two-dimensional cutting. Then, the established stored energy evolution model of the machined material and the strain rate distribution model, the strain distribution model, and the temperature distribution model of the primary shear zone during the cutting are substituted into the shear plane model, and the differential equation of stored energy versus location in the primary shear zone is obtained to obtain the stored energy distribution of the primary shear zone. Finally, the stress field and the temperature field of the primary shear zone are analyzed based on the obtained stored energy distribution, and the cutting force, the cutting temperature, and the material modification are further predicted. The stored energy field runs through the entire cutting process, and the cutting mechanism is explained more deeply, completely, and clearly in a simpler way, greatly promoting the research of the cutting mechanism.

For example, the workpiece material is nickel-based alloy inconel718, the cutting tool is a cemented carbide cutting tool, and parameters of the cutting tool are as follows: a rake angle of 0°, a tool cutting edge angle of 90°, a tool cutting edge inclination of 0°, and a tool tip arc radius of 0.8 mm. The following cutting parameters are used:

| | Cutting | | Depth |
|---|---|---|---|
| Group | speed | Feed | of cut |
| No.: | (m/min) | (mm/r) | (mm) |
| 1 | 18 | 0.1 | 1.0 |
| 2 | 24 | 0.1 | 1.0 |
| 3 | 30 | 0.1 | 1.0 |
| 4 | 36 | 0.1 | 1.0 |
| 5 | 42 | 0.1 | 1.0 |

A method for calculating a stored energy field of the primary shear zone during steady-state cutting of the nickel-based alloy inconel718 includes the following steps:

1) Fitting parameters of a stored energy evolution model of the material based on stress-strain curves of the workpiece material in different deformation conditions, where the model is related to a temperature, a strain, and a strain rate;

Stored energy Eₛ may be represented by a dislocation density ρₜₒₜₐₗ. That is to say:

$${E}_{s} = αμ {b}^{2} {ρ}_{total} / χ .$$

For the inconel718 workpiece material, α=0.5, μ=80000 MPa, b=2.56e−7 mm, and χ=0.6. A total dislocation density is

$${ρ}_{total} = ( 1 - f ) {ρ}_{s} + f {ρ}_{LABs} ,$$

wherein, f is a volume fraction of a geometrically necessary dislocation, which may be expressed by a dislocation cell structure diameter D_{cell} and the dislocation cell wall thickness 8 as:

$$f = {[ ( {D}_{cell} - δ ) / {D}_{cell} ]}^{3} .$$

The dislocation cell wall thickness δ is 1.28×10⁻⁹ m, and the dislocation cell structure diameter is expressed as:

$${D}_{cell} = {k}_{cell} / \sqrt{{ρ}_{total}} ,$$

wherein, k_{cell}=6.4. Evolution equations of the statistical stored dislocation density Σₛ and the geometrically necessary dislocation density ρ_{LABS} with a strain γ are:

$$d {ρ}_{s} / d γ = {( {bD}_{cell} )}^{- 1} \sqrt{{ρ}_{s}} - r {ρ}_{s} ,$$

$$d {ρ}_{LABs} / d γ = \sqrt{2 {ρ}_{m} / 3} {D}_{cell} / δ b .$$

By fitting results of stress-strain curves at different strain rates and different temperatures, the following is obtained:

$$r = [ 87.84 exp ( - \frac{\dot{γ}}{2040} ) + 16.65 ] exp ( 0.00045 T ) ,$$

$${ρ}_{m} = 2.4 \times {10}^{6} {mm}^{- 2} .$$

2) In order to reduce the complexity of the analysis, the primary shear zone is discretized into N infinitesimals from an initial shear plane CD to a final shear plane EF in a normal direction of a main shear plane AB, that is, N+1 planes, where when N is large enough, a strain rate and a temperature in each infinitesimal may be assumed as constants, and in consideration of calculation efficiency and calculation accuracy, N=200.

3) Introducing an equivalent cutting edge model, simplify actual 3D cutting into 2D cutting, and calculate distributions of a strain rate j and a strain y of the primary shear zone according to a shear plane model:

$$\dot{γ} = \{ \begin{matrix}\frac{{\dot{γ}}_{max}}{ks} y & 0 < y < ks \\ \frac{{\dot{γ}}_{max}}{s - ks} ( s - y ) & ks < y < s\end{matrix} ,$$

$$γ = \{ \begin{matrix}\frac{{\dot{γ}}_{max}}{2 ksV sin {ϕ}_{e}} {y}^{2} & 0 < y < ks \\ \frac{{\dot{γ}}_{max}}{2 ( 1 - k ) sV sin {ϕ}_{e}} ( 2 sy - {y}^{2} - 2 ks ) & ks \leq y < s\end{matrix} ,$$

wherein, \acute{γ}ₘₐₓ and k may be expressed as:

$${\dot{γ}}_{max} = \frac{2 V cos {γ}_{e}}{\sqrt{3} s cos ( {ϕ}_{e} - {γ}_{e} )} ,$$

$$k = \frac{cos {ϕ}_{e} cos ( {ϕ}_{e} - {γ}_{e} )}{cos {γ}_{e}} .$$

A thickness of the shear zone is obtained according to the empirical formula of oxley:

$$s = \frac{{a}_{c}}{5.9 sin {ϕ}_{e}} .$$

In order to obtain the shear angle, experiments are usually required to obtain a deformation coefficient. For simplicity, in the present example, an approximate shear angle formula of Merchant is used:

$${ϕ}_{e} = \frac{π}{4} - \frac{β}{2} + \frac{{γ}_{e}}{2} ,$$

wherein, β32 arc tan(fμ) is a friction angle, and f_{μ}=0.35. A cutting speed V, an equivalent rake angle γₑ, a cutting thickness a_{c}, and β are substituted into the foregoing calculation formula, to obtain the strain distribution and the strain rate distribution of the primary shear zone.

According to the distribution laws of the strain and the strain rate, the formula is substituted into a center position of the each infinitesimal, to obtain an average strain and an average strain rate of the each infinitesimal. The average strain and the average strain rate are respectively used as a strain feature value and a strain rate feature value of the each infinitesimal.

According to the heat conduction equation, the temperature value of a K^{th} plane is represented by a temperature value of a (K−1)^{th} plane:

$${T}_{K} = {T}_{K - 1} + \frac{{R}_{1}}{ρ cV sin {ϕ}_{e}} {\int }_{{y}_{K - 1}}^{{y}_{K}} Qdy ,$$

wherein, R₁ is a ratio of mass transfer to heat transfer during the cutting, ρ and c are respectively a density and a specific heat capacity of the workpiece material, y_{K} and yₖ₋₁ are respectively coordinates of the K^{th} plane and the (K−1)^{th} plane, and Q is heat generated per unit time and per unit volume in the each infinitesimal.

4) Deriving a differential equation of stored energy versus location y by using the stored energy evolution model:

$$\frac{{dE}_{s}}{dy} = \frac{{dE}_{s} d γ}{d γ dy} + \frac{{dE}_{s} d \dot{γ}}{d \dot{γ} dy} + \frac{{dE}_{s} dT}{dTdy} .$$

Since the strain rate and the temperature in the each infinitesimal are both regarded as fixed values, the differential equation in the each infinitesimal may be simplified. Finally, stored energy E_{s|K} of the K^{th} plane is calculated by stored energy E_{s|K-1} of the (K−1) th plane:

$${E}_{s \vert K} = {E}_{s \vert K - 1} + \frac{d ψ ( {\dot{γ}}_{AVE} , \overline{T} )}{d γ} \frac{d γ}{dy} dy .$$

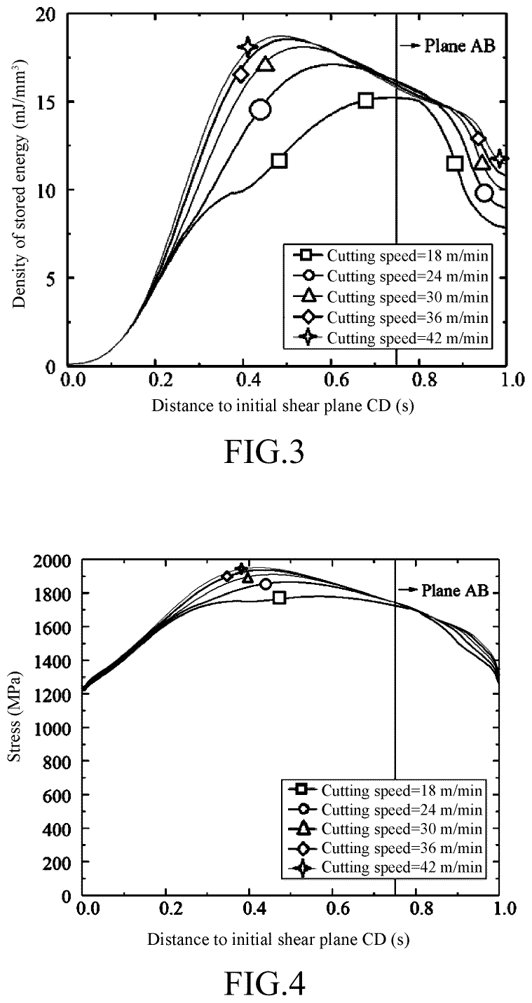

The initial shear plane of the primary shear zone is used as a model boundary. Stored energy of a next plane is calculated in the each infinitesimal according to the foregoing formula, to obtain stored energy of all (N+1)^{th} planes. The stored energy of all planes is used as the stored energy of the location in the primary shear zone. That is to say, the stored energy field distribution of the primary shear zone is obtained. FIG. 3 shows a stored energy field result obtained according to the cutting parameters in the table.

5) Predicting a stress field and a temperature field of the primary shear zone based on the stored energy field, and then analyze the cutting force, the cutting temperature, a chip forming law, and the material modification.

A shear flow stress prediction formula based on the stored energy is obtained as:

$$τ = {τ}_{0} + M ( αμ b \sqrt{{E}_{s} χ / {α}_{s} μ {b}^{2}} ) + {τ}_{1} μ {\{ 1 - {[ \frac{{k}_{b} T}{Δ F} ln ( \frac{{\dot{ε}}_{p}}{{\dot{ε}}_{0}} ) ]}^{\frac{1}{p}} \}}^{\frac{1}{q}} ,$$

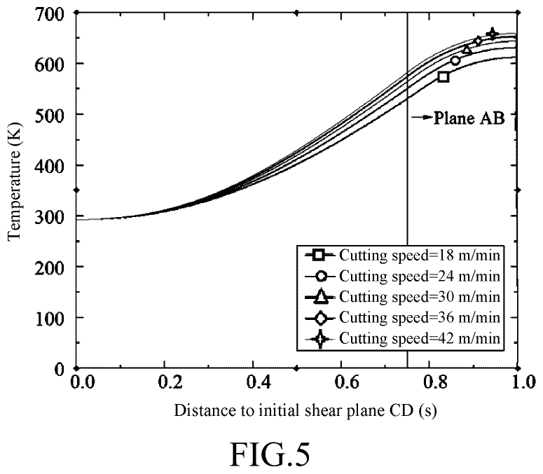

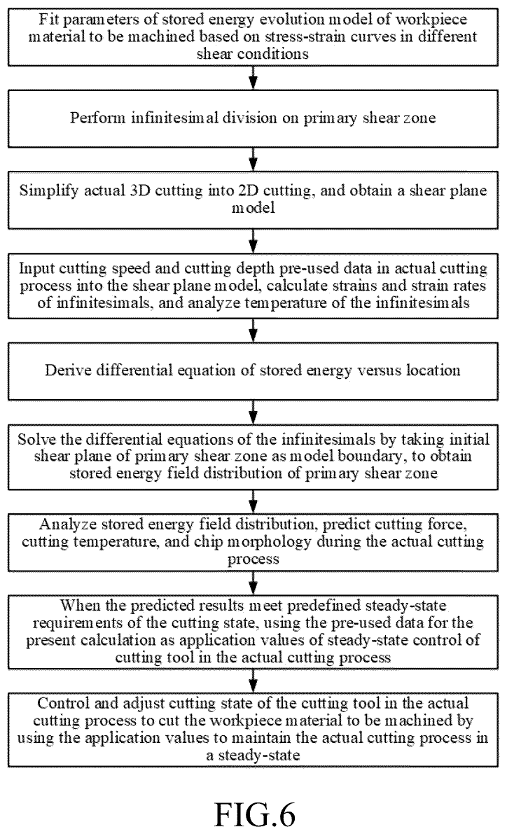

A stress field distribution of the primary shear zone is predicted according to the stored energy field result, as shown in FIG. 4. A temperature field distribution of the primary shear zone is predicted according to the stored energy field result, as shown in FIG. 5.

A predicted stress is used as an input and is substituted into a main cutting force prediction formula. A comparison between a predicted result and an experimental result of the cutting force is shown in the table. It may be learned that the predicted result is quite similar with the experimental result.

| Group No .: | Predicted value (N) | Experimental value (N) | $\frac{\vert Predicted value - Experimental value \vert}{Experimental value} \times 100 \%$ |
|---|---|---|---|
| 1 | 482.343581 | 579.1666667 | 16.72% |
| 2 | 443.7292291 | 557.5980392 | 20.42% |
| 3 | 441.7968373 | 546.8137255 | 19.21% |
| 4 | 427.8047855 | 536.0294118 | 20.19% |
| 5 | 419.3042459 | 533.3333333 | 21.38% |

A chip morphology prediction method is as follows: it is assumed the loading stage exists before the main shear plane and an unloading stage exists after the main shear plane AB. If a stored energy peak occurs at a location before AB, it may be considered that adiabatic shear occurs in the cutting condition and sawtooth chips are formed. In consideration of a hysteresis effect of the adiabatic shear, a critical speed at which the sawtooth chips are generated is about 30 m/min, which is quite in line with the experimental result. Hardness variations of the cut shear zone may be obtained based on a mapping relationship between micro-hardness and stored energy, and a microscopic stored energy distribution of the cut shear zone may be further obtained according to the stored energy distribution.

### Example 2

In a typical implementation of the present invention, the present example discloses a system for calculating a stored energy field of the primary shear zone during steady-state cutting. The system includes:
a fitting unit, an infinitesimal generation unit, and a conversion unit, where the fitting unit is configured to fit a stored energy evolution model of a material, the infinitesimal generation unit is configured to divide the primary shear zone into infinitesimals, and the conversion unit is configured to convert a three-dimensional cutting model to a two-dimensional cutting model; and
a solving module, configured to receive data outputted by the fitting unit, the infinitesimal generation unit, and the conversion unit, calculate a strain and a strain rate of each infinitesimal and analyze the temperature of the each infinitesimal according to the data outputted by the conversion unit, derive a differential equation of stored energy versus location of the primary shear zone by using the stored energy evolution model of the fitting unit, and solve the differential equation of stored energy versus location for the each infinitesimal divided by the infinitesimal generation unit, to obtain a stored energy field distribution of the primary shear zone.

The infinitesimals are a series of discrete infinitesimals generated in a normal direction of the main shear plane on the primary shear zone.

It may be understood that, a pre-processing module may be an existing processor. The processor is connected to a memory in which the program codes of the fitting unit, the infinitesimal generation unit, and the conversion unit in the present example are burned. Alternatively, the pre-processing module includes three processors. The three processors each are connected to a memory in which the program codes of the fitting unit, the infinitesimal generation unit, and the conversion unit in the present example are burned. An output conversion module is further connected to the pre-processing module for reading, analyzing, organizing, assembling, converting, and drawing results outputted by the pre-processing module, and mapping various attributes to inherent names and attributes.

The solution unit is configured to establish a differential equation and a definite solution condition for a mathematical engineering model according to the mathematical engineering model, a numerical discrete algorithm, and a numerical solution method that are preselected, perform calculation of discretized regions for continuous time physical quantities and continuous space physical quantities, and establish an algebraic equation by the numerical solution method to form a solution result.

It may be understood that the solution unit may be an existing processor.

It may be understood that, in the present example, the system described in Embodiment 1 may be used for calculation. Specifically, in the pre-processing module, the fitting unit is configured to perform step (1), the infinitesimal generation unit is configured to perform step (2), the conversion unit is configured to perform step (3), and the solving module is configured to perform step (4) and step (5).

### Example 3

In a typical implementation of the present invention, the present example discloses a method for steady-state control of cutting state, including the following steps:
fitting parameters of a stored energy evolution model of a workpiece material to be machined based on stress-strain curves of the workpiece material to be machined in different deformation conditions;
performing infinitesimal division on the primary shear zone;
simplifying an actual three-dimensional (3D) cutting into a two-dimensional (2D) cutting, obtaining a shear plane model by analyzing the 2D cutting;
inputting multiple groups of data of cutting speed and cutting depth pre-used in an actual cutting process into the shear plane model, calculating a strain and a strain rate of each of infinitesimals, and analyzing temperature of the each of the infinitesimals;
deriving a differential equation of stored energy versus location by using the stored energy evolution model, a strain rate distribution model, a strain distribution model, and a temperature distribution model;
solving the differential equation of stored energy versus location for the each of the infinitesimals by using an initial shear plane of the primary shear zone as a model boundary, to obtain stored energy at each location, so as to obtain a stored energy field distribution of the primary shear zone;
analyzing the stored energy field distribution of the primary shear zone, predicting a cutting force, cutting temperature, and a chip morphology during the actual cutting process;
when the predicted cutting force, cutting temperature, and/or chip morphology obtained from a certain prediction calculation meet the predefined steady-state requirements of the cutting state, the pre-used data of the cutting speed and cutting depth input in the certain prediction calculation are used as application values of steady-state control of a cutting tool in the actual cutting process; and
controlling and adjusting a cutting state of the cutting tool in the actual cutting process to process the workpiece material to be machined by using the application values of the cutting speed and the cutting depth, so as to maintain the actual cutting process in a steady-state and obtain expected material properties of a machined workpiece material.

The method for the steady-state control of the cutting state in an actual cutting process, specially comprises the following steps:

1) Fitting parameters of a stored energy evolution model of the material based on stress-strain curves of the workpiece material in different deformation conditions, where the model is related to a temperature, a strain, and a strain rate;

Stored energy Eₛ may be represented by a dislocation density ρₜₒₜₐₗ, which is:

$${E}_{s} = α μ {b}^{2} {ρ}_{total} / χ .$$

Use a workpiece material of inconel718 as an example.

For the inconel718 workpiece material, α=0.5, μ=80000 MPa, b=2.56e−7 mm, and χ=0.6. A total dislocation density is

$${ρ}_{total} = ( 1 - f ) {ρ}_{s} + f {ρ}_{LABs} ,$$

wherein, f is a volume fraction of a geometrically necessary dislocation, which may be expressed by a dislocation cell structure diameter D_{cell} and the dislocation cell wall thickness δ as:

$$f = {[ ( {D}_{cell} - δ ) / {D}_{cell} ]}^{3} .$$

The dislocation cell wall thickness δ is 1.28×10⁻⁹ m, and the dislocation cell structure diameter is expressed as:

$${D}_{cell} = {k}_{cell} / \sqrt{{ρ}_{total}} ,$$

wherein, k_{cell}=6.4. Evolution equations of the statistical stored dislocation density Ps and the geometrically necessary dislocation density ρ_{LABs} with a strain y are:

$$d {ρ}_{s} / d γ = {( b {D}_{cell} )}^{- 1} \sqrt{{ρ}_{s}} - r {ρ}_{s} , \\ d {ρ}_{LABs} / d γ = \sqrt{2 {ρ}_{m} / 3} {D}_{cell} / δ b .$$

By fitting results of stress-strain curves at different strain rates and different temperatures, the following is obtained:

$$r = [ 87 \text{.84} exp ( - \frac{\dot{γ}}{2040} ) + 16.65 ] exp ( 0.00045 T ) , \\ {ρ}_{m} = 2.4 \times 1 {0}^{6} {mm}^{- 2} .$$

2) In order to reduce the complexity of the analysis, the primary shear zone is discretized into N infinitesimals from an initial shear plane CD to a final shear plane EF in a normal direction of a main shear plane AB, that is, N+1 planes, where when N is large enough, a strain rate and a temperature in each infinitesimal may be assumed as constants, and in consideration of calculation efficiency and calculation accuracy, N=200.

3) Introducing an equivalent cutting edge model, simplify actual 3D cutting into 2D cutting, and calculate distributions of a strain rate j and a strain y of the primary shear zone according to a shear plane model:

$$\dot{γ} = \{ \begin{matrix}\frac{{\dot{γ}}_{ma x}}{ks} y & 0 < y < ks \\ \frac{{\dot{γ}}_{ma x}}{s - ks} ( s - y ) & ks < y < s\end{matrix} , \\ γ = \{ \begin{matrix}\frac{{\dot{γ}}_{ma x}}{2 ksV sin {ϕ}_{e}} {y}^{2} & 0 < y < ks \\ \frac{{\dot{γ}}_{ma x}}{2 ( 1 - k ) sV sin {ϕ}_{e}} ( 2 sy - {y}^{2} - 2 ks ) & ks \leq y < s\end{matrix} ,$$

wherein, \dot{γ}ₘₐₓ and k may be expressed as:

$${\dot{γ}}_{ma x} = \frac{2 V cos {γ}_{e}}{\sqrt{3} s cos ( {ϕ}_{e} - {γ}_{e} )} , \\ k = \frac{cos {ϕ}_{e} cos ( {ϕ}_{e} - {γ}_{e} )}{cos {γ}_{e}} .$$

A thickness of the shear zone is obtained according to the empirical formula of oxley:

$$s = \frac{{a}_{c}}{5.9 sin {ϕ}_{e}} .$$

In order to obtain the shear angle, experiments are usually required to obtain a deformation coefficient. For simplicity, in the present example, an approximate shear angle formula of Merchant is used:

$${ϕ}_{e} = \frac{π}{4} - \frac{β}{2} + \frac{γ}{2} ,$$

wherein, B=arc tan(f_{μ}) is a friction angle, and f_{μ}=0.35. A cutting speed V, an equivalent rake angle γₑ, a cutting thickness α_{c}, and β are substituted into the foregoing calculation formula, to obtain the strain distribution and the strain rate distribution of the primary shear zone.

According to the distribution laws of the strain and the strain rate, the formula is substituted into a center position of the each infinitesimal, to obtain an average strain and an average strain rate of the each infinitesimal. The average strain and the average strain rate are respectively used as a strain feature value and a strain rate feature value of the each infinitesimal.

According to the heat conduction equation, the temperature value of a K^{th} plane is represented by a temperature value of a (K−1)^{th} plane:

$${T}_{K} = {T}_{K - 1} + \frac{{R}_{1}}{ρ cV sin {ϕ}_{e}} {\int }_{{y}_{K - 1}}^{{y}_{K}} Qdy ,$$

wherein, R₁ is a ratio of mass transfer to heat transfer during the cutting, ρ and c are respectively a density and a specific heat capacity of the workpiece material, y_{K} and y_{K-1} are respectively coordinates of the K^{th} plane and the (K−1)^{th} plane, and Q is heat generated per unit time and per unit volume in the each infinitesimal.

4) Deriving a differential equation of stored energy versus location y by using the stored energy evolution model:

$$\frac{{dE}_{s}}{dy} = \frac{{dE}_{s} d γ}{d γ dy} + \frac{{dE}_{s} d \dot{γ}}{d \dot{γ} dy} + \frac{{dE}_{s} dT}{dTdy} .$$

Since the strain rate and the temperature in the each infinitesimal are both regarded as fixed values, the differential equation in the each infinitesimal may be simplified. Finally, stored energy E_{s|K} of the K^{th} plane is calculated by stored energy E_{s|K-1} of the (K−1)^{th} plane:

$${E}_{s \vert K} = {E}_{s \vert K - 1} + \frac{d ψ ( {\dot{γ}}_{AVE} , \overline{T} )}{d γ} \frac{d γ}{dy} dy .$$

The initial shear plane of the primary shear zone is used as a model boundary. Stored energy of a next plane is calculated in the each infinitesimal according to the foregoing formula, to obtain stored energy of all (N+1)^{th} planes. The stored energy of all planes is used as the stored energy of the location in the primary shear zone. That is to say, the stored energy field distribution of the primary shear zone is obtained. FIG. 3 shows stored energy fields result obtained according to the cutting parameters in the table.

5) Predicting a stress field and a temperature field of the primary shear zone based on the stored energy field, and then analyze the cutting force, the cutting temperature, a chip forming law, and the material modification.

A shear flow stress prediction formula based on the stored energy is obtained as:

$$τ = {τ}_{0} + M ( α μ b \sqrt{{E}_{s} χ / {α}_{s} μ {b}^{2}} ) + {τ}_{1} μ {\{ 1 - {[ \frac{{k}_{b} T}{Δ F} ln ( \frac{{\dot{ε}}_{p}}{{\dot{ε}}_{0}} ) ]}^{\frac{1}{p}} \}}^{\frac{1}{q}} ,$$

A stress field distribution of the primary shear zone is predicted according to the stored energy field result, as shown in FIG. 4. A temperature field distribution of the primary shear zone is predicted according to the stored energy field result, as shown in FIG. 5.

(6) Using a predicted stress as an input and is substituted into a main cutting force prediction formula, to analyze and judge the cutting force prediction results.

Wherein, the main cutting force F_{c} prediction formula is as follows:

$${F}_{c} = \frac{τ {a}_{w} {a}_{c} cos ( β - {γ}_{e} )}{cos ( {ϕ}_{e} + β - {γ}_{e} ) sin {ϕ}_{e}} ,$$

wherein, α_{w} is a cutting width and α_{c} is a cutting depth.

When the predicted cutting force, cutting temperature, and/or chip morphology obtained from a certain prediction calculation meet the predefined steady-state requirements of the cutting state, the pre-used data of the cutting speed and cutting depth input in the certain prediction calculation are used as application values of steady-state control of a cutting tool in the actual cutting process.

A chip morphology prediction method is as follows: it is assumed the loading stage exists before the main shear plane and an unloading stage exists after the main shear plane AB. If a stored energy peak occurs at a location before AB, it may be considered that adiabatic shear occurs in the cutting condition and sawtooth chips are formed. Hardness variations of the cut shear zone may be obtained based on a mapping relationship between micro-hardness and stored energy, and a microscopic stored energy distribution of the cut shear zone may be further obtained according to the stored energy distribution.

(7) In the actual cutting process, the application values of the cutting speed and cutting depth can be input into a computer numerical control (CNC) machine tool, or operating corresponding control levers on a regular cutting lathe by an operator according to the application values of the cutting speed and cutting depth, the cutting tool can be controlled and adjusted to perform a steady-state machining on the workpiece material to be machined according to the input application values during the actual cutting process, and ultimately obtain the expected material properties of the machined workpiece material.

It can be understood that the predefined steady-state requirements for cutting states described in the present example may vary depending on the workpiece material to be machined, as well as the type and model of the cutting tool. Those skills in the art can set and adjust them based on experience, actual needs, and/or special requirements. The present invention is not particularly limited.

It can be understood that the example can adopt the example described in Example 1, but is not limited to the example described. Specifically, the workpiece material to be machined is the nickel-based alloy inconel718, the cutting tool is a cemented carbide cutting tool, and parameters of the cutting tool are as follows: a rake angle of 0°, a tool cutting edge angle of 90°, a tool cutting edge inclination of 0°, and a tool tip arc radius of 0.8 mm. The following cutting parameters are used:

| | Cutting | | Depth |
|---|---|---|---|
| Group | speed | Feed | of cut |
| No.: | (m/min) | (mm/r) | (mm) |
| 1 | 18 | 0.1 | 1.0 |
| 2 | 24 | 0.1 | 1.0 |
| 3 | 30 | 0.1 | 1.0 |
| 4 | 36 | 0.1 | 1.0 |
| 5 | 42 | 0.1 | 1.0 |

The cutting force, the cutting temperature, and the forming law of the cutting chip, etc., are predicted. Based on the prediction results, and taking the adiabatic shear hysteresis effect into consideration, the critical velocity for generating serrated chips is approximately 30 m/min.

The above descriptions are merely preferred embodiments of the present invention and are not intended to limit the present invention. A person skilled in the art may make various alterations and variations to the present invention. Any modification, equivalent replacement, or improvement made within the spirit and principle of the present invention shall fall within the protection scope of the present invention.

What is claimed is:

1. A method for steady-state control of cutting state, being implemented based on a computer numerical control (CNC) machine tool or a cutting lathe, and comprising steps of:
fitting parameters of a stored energy evolution model of a workpiece material to be machined based on stress-strain curves of the workpiece material to be machined in different deformation conditions;
performing infinitesimal division on the primary shear zone;
simplifying an actual three-dimensional (3D) cutting into a two-dimensional (2D) cutting, obtaining a shear plane model by analyzing the 2D cutting;
inputting multiple groups of data of cutting speed and cutting depth pre-used in an actual cutting process into the shear plane model, calculating a strain and a strain rate of each of infinitesimals, and analyzing temperature of the each of the infinitesimals;
deriving a differential equation of stored energy versus location by using the stored energy evolution model, a strain rate distribution model, a strain distribution model, and a temperature distribution model;
solving the differential equation of stored energy versus location for the each of the infinitesimals by using an initial shear plane of the primary shear zone as a model boundary, to obtain stored energy at each location, so as to obtain a stored energy field distribution of the primary shear zone;
analyzing the stored energy field distribution of the primary shear zone, predicting a cutting force, cutting temperature, and a chip morphology during the actual cutting process;
when the predicted cutting force, cutting temperature, and/or chip morphology obtained from a certain prediction calculation meet the predefined steady-state requirements of the cutting state, the pre-used data of the cutting speed and cutting depth input in the certain prediction calculation are used as application values of steady-state control of a cutting tool in the actual cutting process; and
controlling and adjusting a cutting state of the cutting tool in the actual cutting process to process the workpiece material to be machined by using the application values of the cutting speed and the cutting depth, so as to maintain the actual cutting process in a steady-state and obtain expected material properties of a machined workpiece material.

2. The method for steady-state control of cutting state according to claim 1, wherein fitting of the parameters of the stored energy evolution model of the workpiece material to be machined comprises: fitting the parameters of the stored energy evolution model of the workpiece material to be machined about to a temperature, a strain, and a strain rate based on the stress-strain curves of the workpiece material to be machined in the different deformation conditions.

3. The method for steady-state control of cutting state according to claim 1, wherein
after the infinitesimal division on the primary shear zone, the strain, the strain rate, and the temperature in the each infinitesimal are set as constants.

4. The method for steady-state control of cutting state according to claim 1, wherein before calculation of the strain and the strain rate of the each of the infinitesimals and analysis of the temperature of the each of the infinitesimals, an equivalent cutting edge model is introduced to simplify the actual three-dimensional (3D) cutting into the two-dimensional (2D) cutting, the strain and the strain rate of the each of the infinitesimals are calculated according to the shear plane model, and the temperature of the each of the infinitesimals is analyzed according to a heat conduction equation.

5. The method for steady-state control of cutting state according to claim 1, wherein
during the analysis of the temperature of the each of the infinitesimals, according to the heat conduction equation, a temperature value of a K^{th} plane is represented by a temperature value of a (K−1)^{th} plane.

6. The method for steady-state control of cutting state according to claim 1, wherein
a line connecting two end points of an cutting edge of the cutting tool in the actual cutting process projected on a base plane is defined as an equivalent cutting edge, an equivalent angle of the equivalent cutting edge is calculated by using a cutting tool angle of the equivalent cutting edge as a cutting angle of the cutting tool in the actual cutting process, and then a strain distribution and a strain rate distribution of the primary shear zone are calculated by using a normal rake angle of the equivalent cutting edge as an input parameter of the shear plane model.

7. The method for steady-state control of cutting state according to claim 1, wherein during calculation of stored energy of each discrete plane of the primary shear zone, stored energy of a K^{th} plane is obtained by integration of stored energy of a (K−1)^{th} plane.

8. The method for steady-state control of cutting state according to claim 1, wherein
stored energy-based shear stress field prediction is based on a mapping relationship between stored energy and a dislocation density and a mapping relationship between a shear flow stress and a dislocation density.

9. The method for steady-state control of cutting state according to claim 1, wherein controlling and adjusting the cutting state of the cutting tool in the actual cutting process to process the workpiece material to be machined by using the application values of the cutting speed and the cutting depth comprises: inputting the application values of the cutting speed and cutting depth into the CNC machine tool, or operating corresponding control levers on the cutting lathe by an operator according to the application values of the cutting speed and cutting depth, to control and adjust the cutting tool to perform a steady-state machining on the workpiece material to be machined according to the input application values during the actual cutting process, and obtain the expected material properties of the machined workpiece material.
